(19) United States
(12) Patent Application Publication
(10) Pub. No.: US 2002/0047274 A1
(43) Pub. Date: Apr. 25, 2002

(54) Chute type powerplant

(76) Inventor: Herbert L. Williams, E. Palatka, FL (US)

Correspondence Address: HERBERT L. WILLIAMS, 109 RIVERS EDGE DRIVE, E. PALATKA, FL, 32131, US

(21) Appl. No.: 09/960,918

(22) Filed: Sep. 24, 2001

Related U.S. Application Data
(60) Provisional application No. 60/233,754, filed on Sep. 19, 2000.

(51) Int. Cl. H02P 9/04

(52) U.S. Cl. 290/54

(57) ABSTRACT

The invention produces electricity by the use of a continuous loop cable drawn by a water current through the use of sea anchors (chutes).

### CROSS-REFERENCE TO RELATED APPLICATIONS

“Not applicable”

### STATEMENT REGARDING FEDERALLY SPONSORED RESEARCH OR DEVELOPMENT

“Not applicable”

### REFERENCE TO A MICROFICHE APPENDIX

“Not applicable”

### BACKGROUND OF THE INVENTION

The invention is a machine for producing electricity from a water current. A provisional application 60/233,754 filing date Sep. 19, 2000 has been filed. The name has been changed from “Powerplant for producing electricity from a body of water which has a flow” to “Chute type powerplant”. The invention has been simplified from the above provisional application by omitting the use of a hydraulic system.

This machine is designed to primarily be used in slower (low head) currents where propeller type turbines are not very efficient. A good application for this would be ocean currents. Although ocean currents have tremendous energy potential, they do not readily lend themselves to existing turbine technologies. This invention will work in the 1 to 5 knot velocity ranges where present ones do not perform well.

### BRIEF SUMMARY OF THE INVENTION

This invention deals with the need to be more efficient in slow velocity currents by converting the current energy to a tension energy by the use of drag chutes. A tension energy can them be readily transferred to a rotational energy needed to turn a generator.

### BRIEF DESCRIPTION OF THE SEVERAL VIEWS OF THE DRAWING

FIG. 1. is the anchoring cables.

FIG. 2. is the open area in the center of the frame.

FIG. 3. is the platform that is anchored to the bottom.

FIG. 4. is the housing.

FIG. 5. is the continuous loop of cable.

FIG. 6. is the drag chutes that do the work of tensioning (pulling the cable downstream).

FIG. 7. is the geared generator that produces the electricity.

FIG. 8. is the gear that attaches to the housing.

FIG. 9. is the gear that is attached to the shaft of the geared generator.

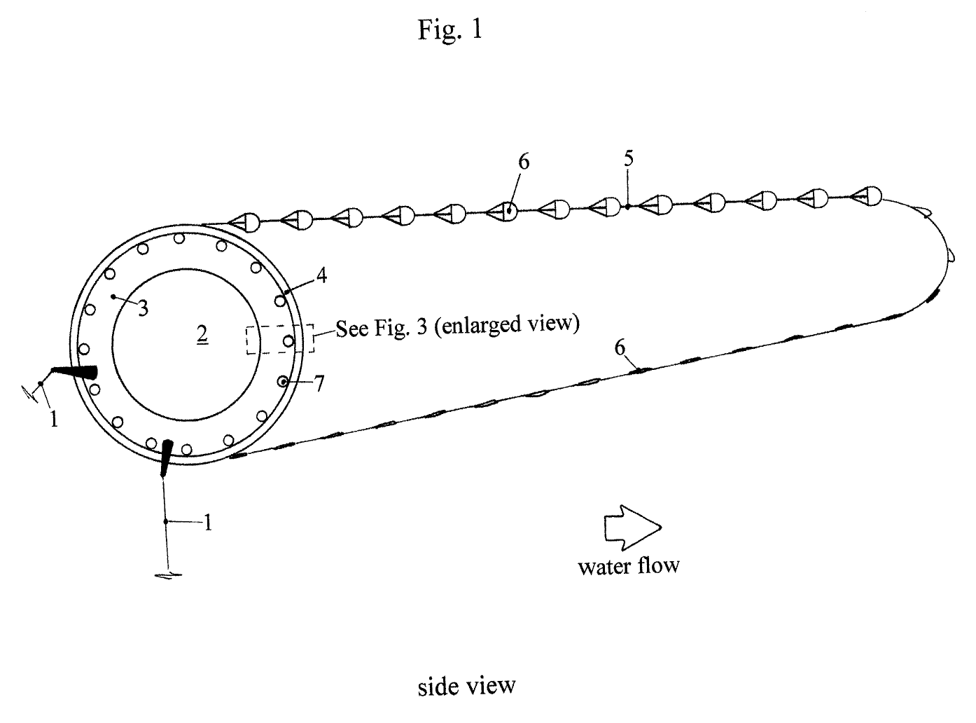

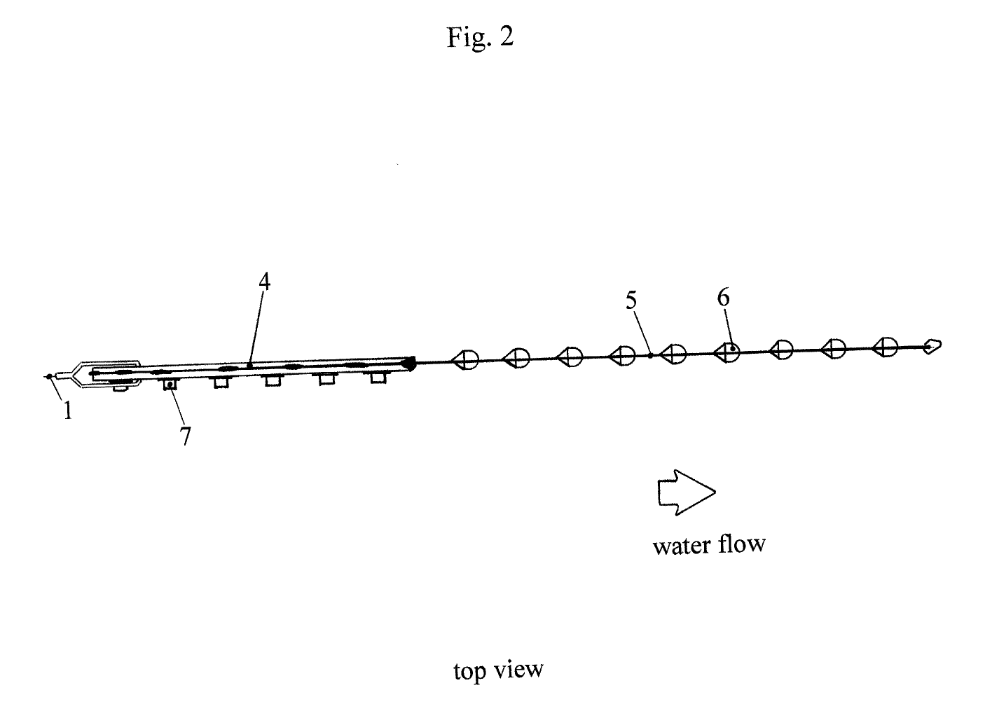

### DETAILED DESCRIPTION OF THE INVENTION

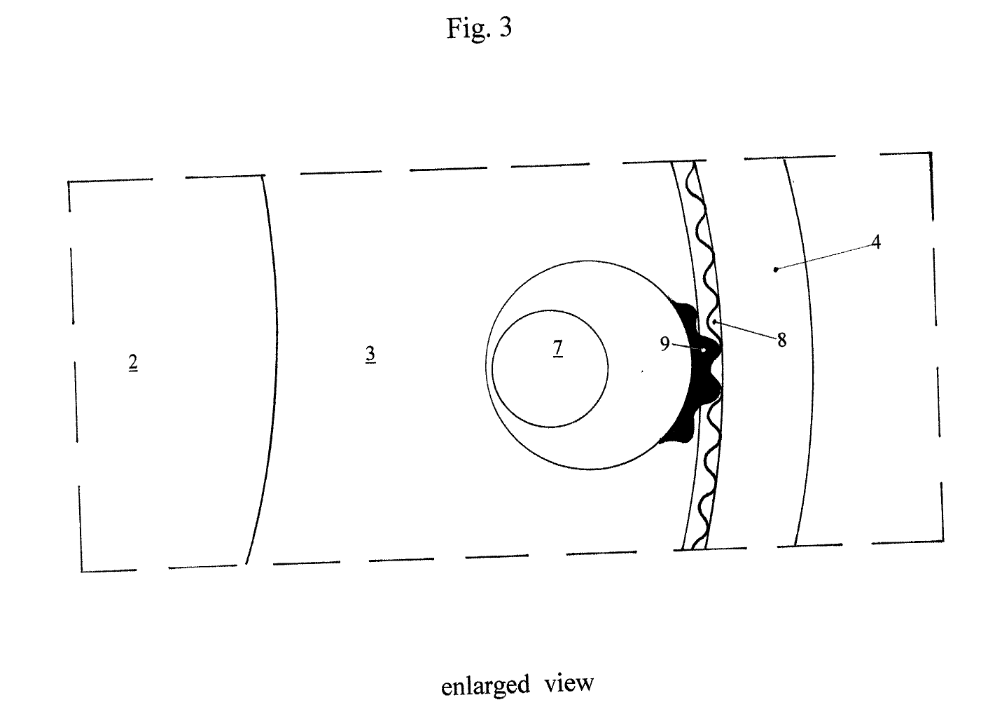

The invention is old in its technologies but new in its method of utilizing them. takes the idea of a plurality of drag chutes (sea anchors) 6 and attaches them around a continuous loop of cable 5 which is arraigned in such a manner that half the drag chutes 6 are deployed (spread open) being moved downstream and half are collapsed being moved upstream. The half of the drag chutes 6 moving downstream are doing the work while the half moving upstream are being positioned to do work. The cable 5 is arraigned in such a manner that its continuous movement turns the housing 4 located around the perimeter of the frame 3. The frame 3 is stationary and secured to the bottom with an anchoring system 1. Around the perimeter of the frame 3 is attached a plurality of direct drive generators 7 which are turned by the outer housing 4. On the inside of the housing 4 is a gear 8. On the shaft of each generator 7 drive is a mating gear 9. These generator drive gears 9 do the work of turning the generators 7 and also hold the housing 4 in position. The generators produce electricity, which is tied in to the electrical grid on shore. The entire process takes place beneath the water surface. The frame can have an open area 2 in its center or be filled for additional flotation. The energy can be transferred from the housing to the generators by the use of gears (as is shown in FIG. 3) or by a hydraulic system as is described in the provisional application referred to above in THE BACKGROUND OF THE INVENTION.

What I claim as my invention is:

1. A powerplant, anchored in a flow of water, which gets its energy to turn a plurality of generators from an outer housing that is rotated by a cable being pulled downstream by a plurality of drag chutes.

2. A powerplant of claim 1 which has a plurality of generators attached to a stationary frame.

3. A powerplant of claim 1 whose outer housing rotates around a stationary frame.

4. A powerplant of claim 1 that gets its energy from a plurality of drag chutes.

5. A powerplant of claim 1 whose outer rotating housing is held in place by rotating gears which are attached to a plurality of generators.

6. A powerplant of claim 1 which uses a cable to transfer energy from drag chutes to an outer housing.

7. A powerplant of claim 1 that uses the rotational energy from an outer geared housing to turn electric generators.

8. A method of producing electricity by the use of a continuous loop of cable with drag chutes attached to it.

9. A method of producing electricity with a plurality of generators which are attached to the periphery of a stationary frame whereas all the generators are being rotated by one common outer housing.

10. A method of using one geared housing to turn a plurality of generators.

11. An electric powerplant whose outer housing rotates around a stationary inner frame and is not mechanically attached to said inner frame.

12. An electric powerplant of claim 11 which transfers energy from its outer housing to its inner frame without the use of a central shaft.

13. An electric powerplant of claim 11 which converts tension energy from a cable being pulled downstream to rotational energy to produce electricity.

14. A method of producing electricity by the use of drag chutes being pulled downstream.
